(19) United States
(12) Patent Application Publication
(10) Pub. No.: US 2001/0016485 A1
(43) Pub. Date: Aug. 23, 2001

(54) Method for selectively rejecting a call in a mobile station

(76) Inventor: Nam-Su Bok, Songnam-shi (KR)

Correspondence Address: ROBERT E. BUSHNELL, 1522 K STREET NW, SUITE 300, WASHINGTON, DC, 200051202

(21) Appl. No.: 09/734,617

(22) Filed: Dec. 13, 2000

(30) Foreign Application Priority Data
Dec. 13, 1999 (KR) 57092/1999

(51) Int. Cl. H04M 1/66

(52) U.S. Cl. 455/411; 455/565

(57) ABSTRACT

A method for selectively rejecting a call in a mobile station, includes the steps of registering the information of the subscribers selected by the user of the mobile station for rejecting their calls in a mobile communications system, and dismissing a call for the mobile station when the call is generated by one of the subscribers registered in the mobile communications system. The calls of the registered subscribers may be automatically switched to a call switching phone number or a user's private sound box registered by the user in the mobile communications system. Preferably, the mobile communications system sends a message to notify the caller of rejecting the call.

### CLAIM OF PRIORITY

This application makes reference to, incorporates the same herein, and claims all benefits accruing under 35 U.S.C. §119 from my application entitled METHOD FOR REJECTING SELECTIVE CALL OF MOBILE COMMUNICATION SET filed with the Korean Industrial Property Office on Dec. 13, 1999 and there duly assigned Ser. No. 57092/1999.

### BACKGROUND OF THE INVENTION

1. Field of the Invention

The present invention relates to a method for selectively rejecting a call in a mobile station, and more particularly a method for registering the phone numbers of the subscribers selected for rejecting their calls.

2. Description of the related art

Conventionally, the mobile station or phone is provided with a means for rejecting calls when the user wants not to receive the calls. However, the conventional means can only reject all calls without any selection of the subscribers with whom the user does not want to communicate.

U.S. Pat. No. 6,085,080 entitled Rejection of Incoming and Outgoing Calls in WLL Terminal to Rahikainen et al. discloses a method and apparatus for registering telephone numbers to be screened in a wireless communication system. What is still needed is a method for switching a telephone call to another number or to a private sound box if the call originates from one of the numbers on the registry. What is further needed is a method of informing the caller that his or her call has been rejected.

### SUMMARY OF THE INVENTION

It is an object of the present invention to provide a method for rejecting the calls from the subscribers selected by the user of a mobile station.

It is another object of the present invention to provide a method for switching the calls from the subscribers selected for rejection to a registered call switching phone number.

It is still another object of the present invention to provide a method for dismissing the calls from the selected subscribers after sending a message to notify them of the rejecting the calls.

It is further another object of the present invention to provide a method for switching the calls from the subscribers selected by the user of a mobile station to the user's private sound box.

It is yet another object of the present invention to notify a caller that his or her call has been rejected by the called party in a cellular system.

According to an aspect of the present invention, a method for selectively rejecting a call in a mobile station, includes the steps of registering the information of the subscribers selected by the user of the mobile station for rejecting their calls in a mobile communications system, and dismissing a call for the mobile station when the call is generated by one of the subscribers registered in the mobile communications system. The calls of the registered subscribers may be automatically switched to a call switching phone number or auser's private sound box registered by the user in the mobile communications system. Preferably, the mobile communications system sends a message to notify the caller of rejecting the call.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram for illustrating the fundamental structure of a mobile communications system for which the inventive method is applied;

FIG. 2 is a flow chart for illustrating the procedure of activating the selective call rejection in a mobile communications system according to the present invention;

FIG. 3 is a flow chart for illustrating the procedure of deactivating the selective call rejection in a mobile communications system according to the present invention;

FIG. 4 is a flow chart for illustrating the procedure of registering a call switching phone number to which the calls selectively rejected calls are switched in a mobile communications system according to the present invention;

FIG. 5 is a flow chart for illustrating the procedure of deleting a call switching phone number in a mobile communications system according to the present invention;

FIG. 6 is a flow chart for illustrating the procedure of registering the information of the subscribers selected by the user of a mobile station for rejecting their call in a mobile communications system according to the present invention;

FIG. 7 is a flow chart for illustrating the procedure of deleting the information of the subscribers selected by the user of a mobile station for rejecting their call from a mobile communications system according to the present invention;

FIG. 8 is a schematic diagram for showing a list containing the information of the subscribers registered for selective call rejection in a mobile communications system according to the present invention;

FIG. 9 is a flow chart for illustrating the procedure of dismissing a call from one of the subscribers registered for selective rejection in a mobile communications system according to the present invention;

FIG. 10 is a flow chart for illustrating the procedure of connecting a call from a subscriber not registered for selective rejection in a mobile communications system according to the present invention; and

FIG. 11 is a flow chart for illustrating the procedure of switching a call from one of the subscribers registered for selective rejection to a call switching phone number registered in a mobile communications system according to the present invention.

### DETAILED DESCRIPTION OF THE PREFERRED EMBODIMENT

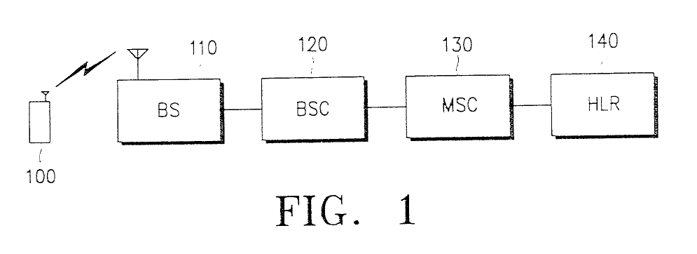

Referring to FIG. 1, a mobile communications system comprises mobile station (MS) 100, base station (BS) 110, base station control (BSC) 120, mobile switching control (MSC) 130, and home location register (HLR) 140. The user presses the selected keys of MS 100 to activate/deactivate selective call rejection, to register/delete a call switching phone number, and to register/delete the list of the subscribers selected for rejecting their calls, so that the key signals are sent through BSC 120 to MSC 130. Then, MSC 130 causes HLR 140 to register the data concerning the functions selected by MS 100.

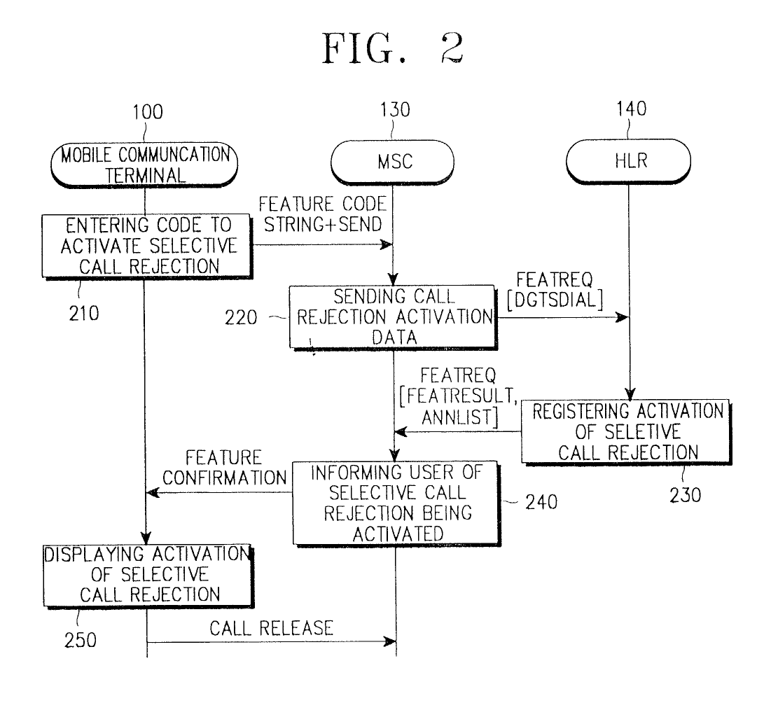

Describing the procedure of activating the selective call rejection with reference to FIGS. 1 and 2, MS 100 sends the feature code (string+SEND) to MSC 130 on the user's request in step 210. For example, pressing keys *65+SEND of MS 100 may activate the selective call rejection. Then, MSC 130 sends the selective call rejection activation data FEATREQ[DGTSDIAL] to HLR 140 in step 220. Then, HLR 140 registers the activation of the selective call rejection, sending its registration data FEATREG[FEATRESULT, ANNLIST] to MSC 130 in step 230. Then, MSC 130 sends the feature confirmation to inform the user of the selective call rejection being activated in step 240. The MS 100 displays the activation of the selective call rejection on the display screen in step 250, then ending the call.

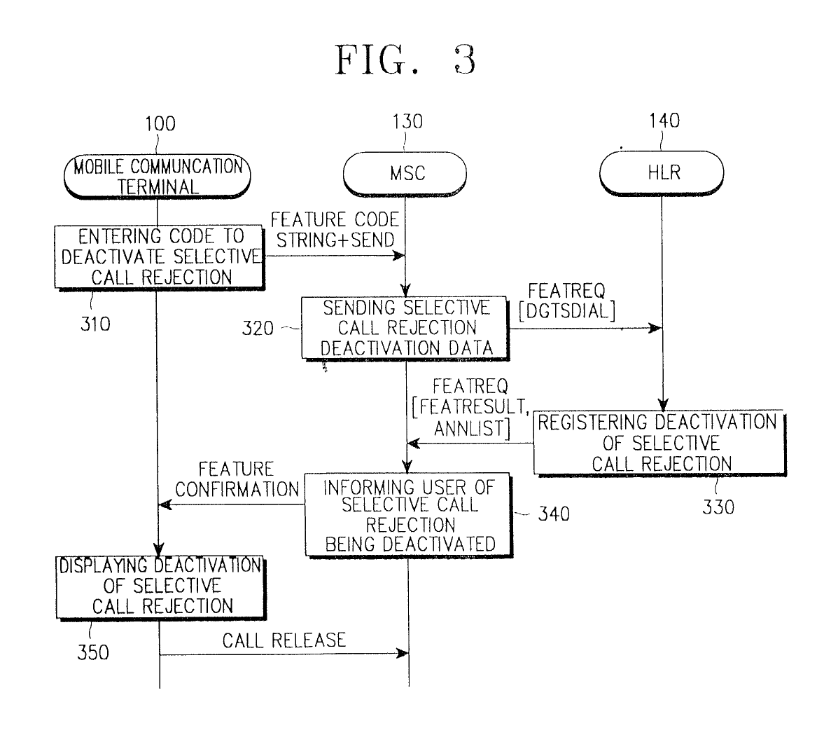

Describing the procedure of deactivating the selective call rejection with reference to FIGS. 1 and 3, MS 100 sends the feature code (string+SEND) to MSC 130 on the user's request in step 310. For example, pressing keys *650+SEND of MS 100 may deactivate the selective call rejection. Then, MSC 130 sends the selective call rejection deactivation data FEATREQ[DGTSDIAL] to HLR 140 in step 320. Then, HLR 140 registers the deactivation of the selective call rejection, sending its registration data FEATREG[FEATRESULT, ANNLIST] to MSC 130 in step 330. Then, MSC 130 sends the feature confirmation to inform the user of the selective call rejection being deactivated in step 340. The MS 100 displays the deactivation of the selective call rejection on the display screen in step 350, then ending the call.

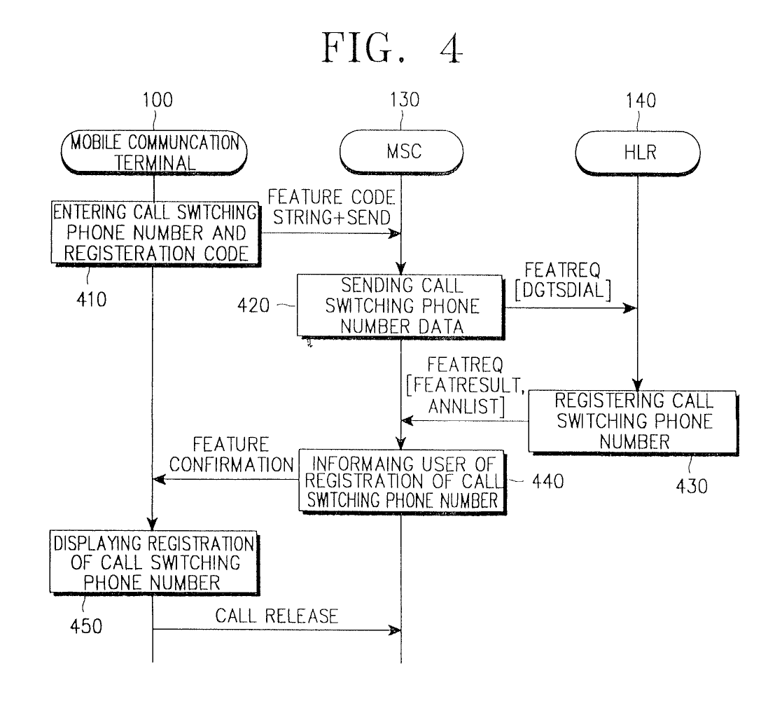

Describing the procedure of registering a call switching phone number to which the calls of the subscribers selected for rejection are switched with reference to FIGS. 1 and 4, MS 100 sends the feature code (string+SEND) to represent the call switching phone number and registration code to MSC 130 on the user's request in step 410. Then, MSC 130 sends the call switching phone number data FEATREQ[DGTSDIAL] to HLR 140 in step 420. Then, HLR 140 registers the call switching phone number, sending its registration data FEATREG[FEATRESULT, ANNLIST] to MSC 130 s in step 430. Then, MSC 130 sends the feature confirmation to inform the user of registration of the call switching phone number in step 440. The MS 100 displays the registration of the call switching phone number on the display screen in step 450, then ending the call.

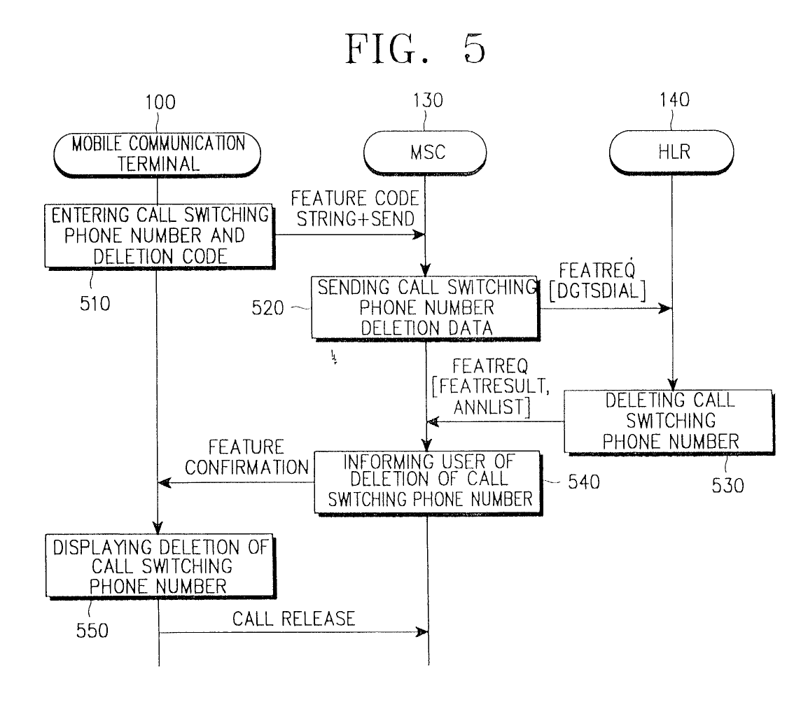

Describing the procedure of deleting the call switching phone number with reference to FIGS. 1 and 5, MS 100 sends the feature code (string+SEND) to represent the call switching phone number and deletion code to MSC 130 on the user's request in step 510. Then, MSC 130 sends the call switching phone number deletion data FEATREQ[DGTSDIAL] to HLR 140 in step 520. Then, HLR 140 deletes the call switching phone number, sending its deletion data FEATREG[FEATRESULT, ANNLIST] to MSC 130 in step 530. Then, MSC 130 sends the feature confirmation to inform the user of deletion of the call switching phone number in step 540. The MS 100 displays the deletion of the call switching phone number on the display screen in step 550, then ending the call.

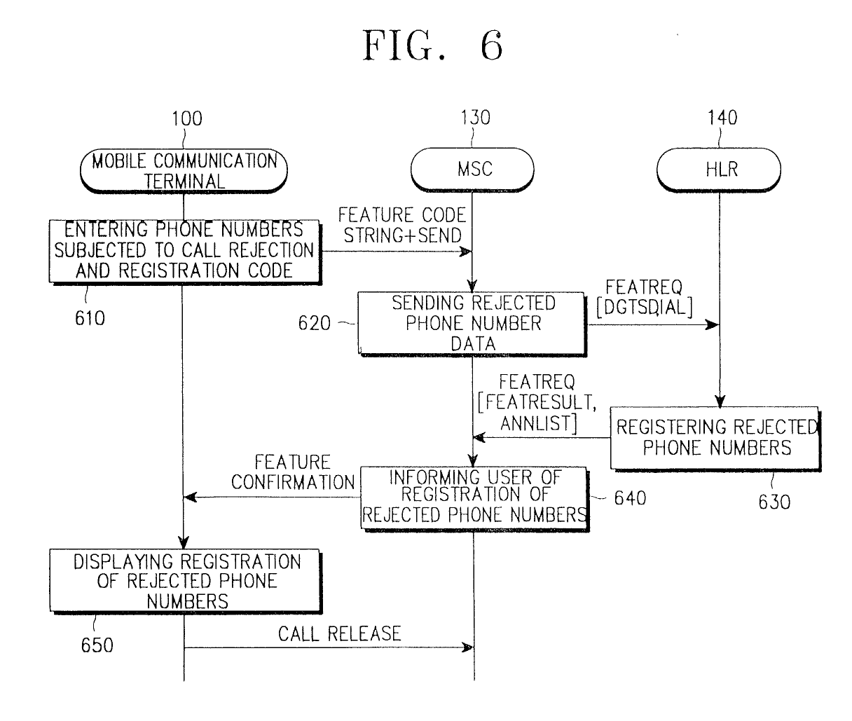

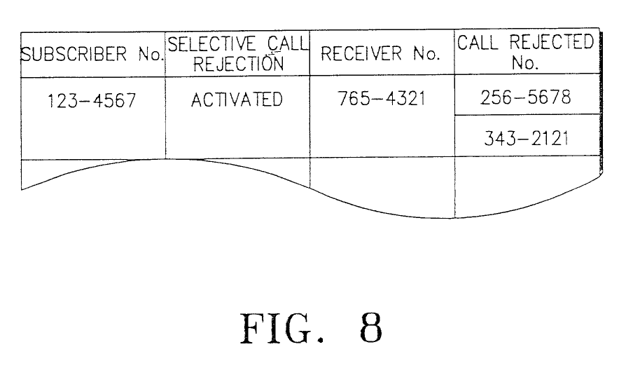

Describing the procedure of registering the phone numbers of the subscribers selected for rejecting their calls in the call rejection list as shown in FIG. 8, with reference to FIGS. 1 and 6, MS 100 sends the feature code (string+SEND) to represent the phone numbers subjected to the call rejection and registration code to MSC 130 on the user's request in step 610. Then, MSC 130 sends the rejected phone number data FEATREQ[DGTSDIAL] to HLR 140 in step 620. Then, HLR 140 registers the rejected phone numbers, sending its registration data FEATREG[FEATRESULT, ANNLIST] to MSC 130 in step 630. Then, MSC 130 sends the feature confirmation to inform the user of the registration of the rejected phone numbers in step 640. The MS 100 displays the registration of the rejected phone numbers on the display screen in step 650, then ending the call.

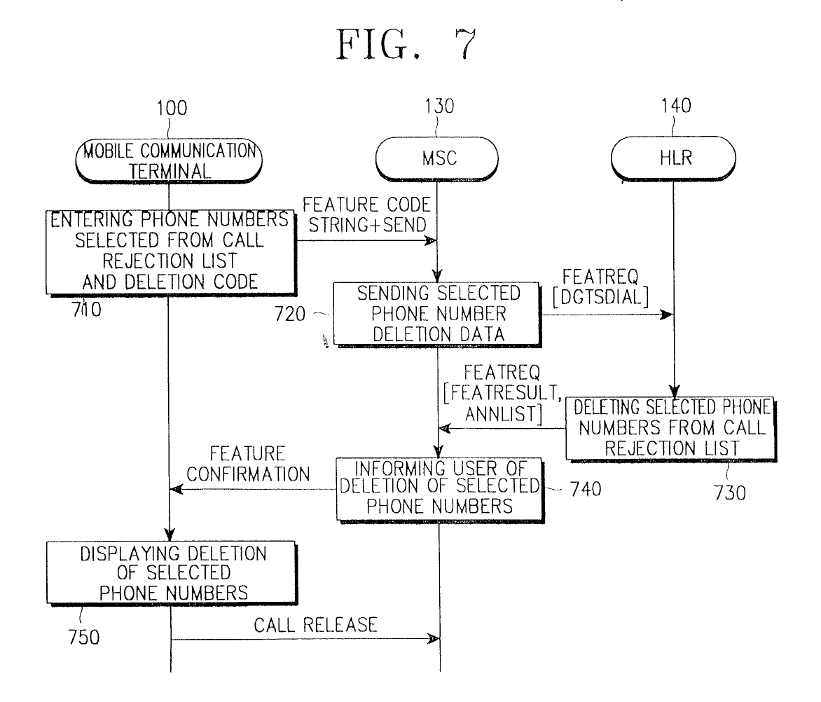

Describing the procedure of deleting the phone numbers of the rejected subscribers from the call rejection list as shown in FIG. 8, with reference to FIGS. 1 and 7, MS 100 sends the feature code (string+SEND) to represent the phone numbers selected by the user from the call rejection list and deletion code to MSC 130 in step 710. Then, MSC 130 sends the selected phone number deletion data FEATREQ[DGTSDIAL] to HLR 140 in step 720. Then, HLR 140 deletes the selected phone numbers from the call rejection list, sending its deletion data FEATREG[FEATRESULT, ANNLIST] to MSC 130 in step 730. Then, MSC 130 sends the feature confirmation to inform the user of the deletion of the selected phone numbers from the call rejection list in step 740. The MS 100 displays the deletion of the selected phone numbers on the display screen in step 750, then ending the call.

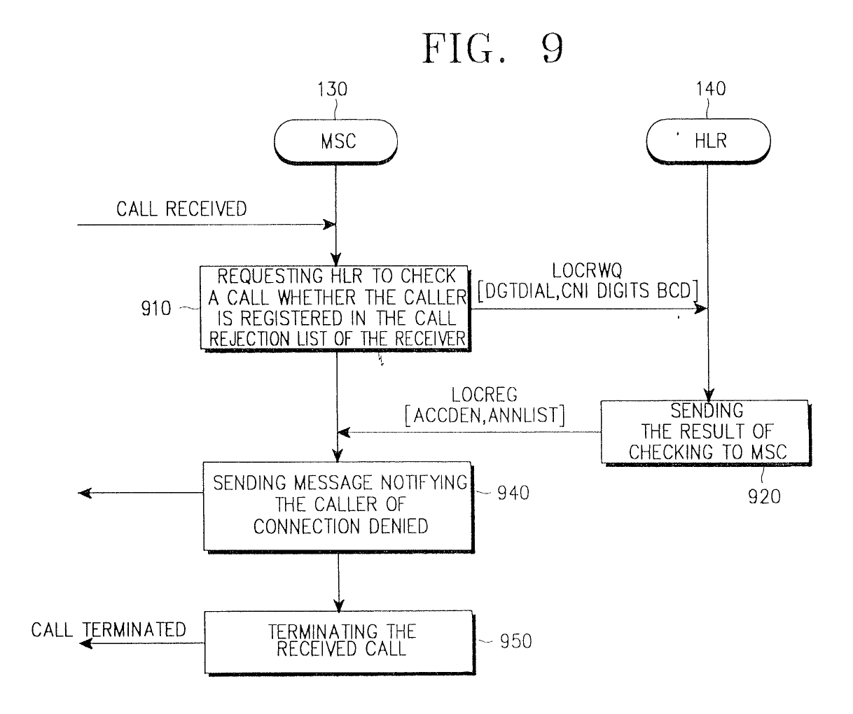

Describing the procedure of rejecting a call from one of the subscribers registered for rejecting their calls with reference to FIGS. 1 and 9, MSC 130 requests HLR 140 to check a received call whether the caller is registered in the call rejection list of the receiver in step 910. Then, HLR 140 sends the result of the checking to MSC 130 in step 920. If the caller is registered in the call rejection list, MSC 130 sends a message notifying the caller of connection denied in step 940, then terminating the call.

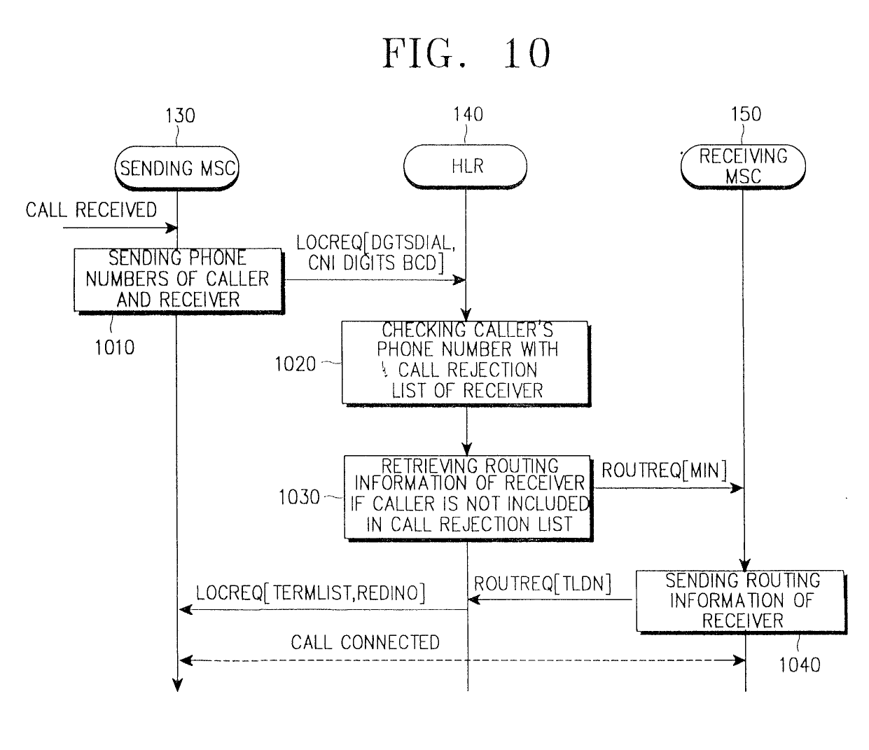

Describing the procedure of connecting a call of a caller not registered in the selective call rejection of the receiver with reference to FIGS. 1 and 10, MSC 130 sends the phone numbers of the caller and receiver to HLR 140 in step 1010 as shown in FIG. 10. Then, HLR 140 checks the caller's phone number with the call rejection list of the receiver in step 1020. If the caller is not included in the call rejection list, HLR request the receiving MSC 150 of the routing information of the receiver in 1030. Then, the receiving MSC 150 sends the routing information of the receiver to HLR 140 in step 1040. Finally, the sending MSC 130 connects the call with receiver.

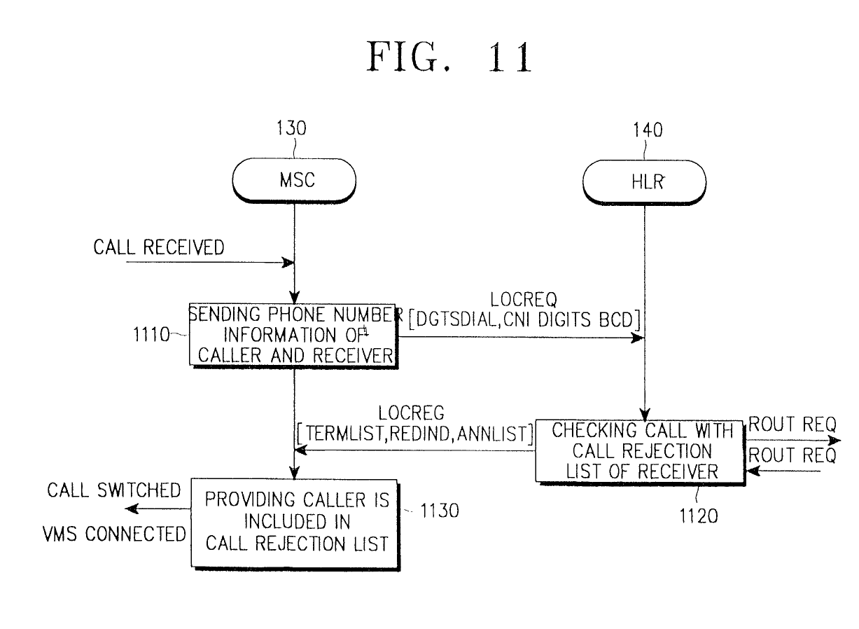

Describing the procedure of switching a call of a caller registered in the call rejection list to a call switching phone number with reference to FIGS. 1 and 11, MSC 130 sends the phone number information of the caller and receiver to HLR 140 in step 1110. Then, HLR 140 checks the call with the call rejection list of the receiver, sending the result to MSC 130 in step 1120. If the caller is included in the call rejection list, MSC 130 switches the call to the call switching phone number or private sound box registered by the receiver.

While the present invention has been described in connection with specific embodiments accompanied by the attached drawings, it will be readily apparent to those skilled in the art that various changes and modifications may be made thereto without departing the gist of the present invention.

What is claimed is:

1. A method for selectively rejecting a call in a mobile station, comprising the steps of:
registering information in a home location register of the subscribers selected by the user of said mobile station for rejecting their calls in a mobile communications system; and
dismissing a call for said mobile station when said call is generated by one of said subscribers registered in said mobile communications system.

2. A method as defined in claim 1, wherein said information is the phone numbers.

3. A method as defined in claim 1, further including the step of sending a message to notify the caller of said user not wanting the communication before dismissing said call.

4. A method as defined in claim 1, further including the step of connecting said call with said mobile station when the caller is not one of said subscribers registered in said mobile communications system.

5. A method for selectively rejecting a call in a mobile station, comprising the steps of:
registering the information of the subscribers selected by the user of said mobile station for rejecting their calls in a mobile communications system; and
registering a call switching phone number, whereby the calls of the selected subscribers are switched to said call switching phone number.

6. A method for selectively rejecting a call in a mobile station, comprising the steps of:
registering the information of the subscribers selected by the user of said mobile station for rejecting their calls in a mobile communications system; and
registering a private sound box of said user, whereby the calls of the selected subscribers are switched to said private sound box.

7. A method for selectively rejecting a call in a mobile station, comprising the steps of:
sending selective call rejection activation code, the phone numbers of the subscribers selected by the user of said mobile phone for rejecting their calls, and a call switching phone number to a mobile switching control (MSC) to register them in a home location register (HLR); and
dismissing a call for said mobile station when said call is generated by one of said subscribers registered in said mobile communications system.

8. A method as defined in claim 7, further including the step of sending a message to notify the caller of said user not wanting the communication before dismissing said call.

9. A method as defined in claim 7, further including the step of connecting said call with said mobile station when the caller is not one of said subscribers registered in said mobile communications system.

10. A method as defined in claim 7, further including the step of switching the rejected call to the registered call switching phone number.

11. A method as defined in claim 7, further including the step of sending selective call rejection deactivation code and the selected phone numbers to said MSC to nullify the registered selective call rejection.
